(19) United States
(12) Patent Application Publication
(10) Pub. No.: US 2008/0055397 A1
(43) Pub. Date: Mar. 6, 2008

(54) IMAGE-LOCATION IMPRINTER, METHOD OF IMPRINTING A LOCATION ON AN IMAGE AND SYSTEM EMPLOYING THE SAME

(75) Inventors: Assaf Landschaft, Munich (DE); Laurent Mauguee, Munchen (DE); Shajith Thengummootil, Bangalore (IN)

Correspondence Address: HITT GAINES, PC;LSI Corporation, PO BOX 832570, RICHARDSON, TX, 75083, US

(73) Assignee: Agere Systems Inc., Allentown, PA (US)

(21) Appl. No.: 11/469,041

(22) Filed: Aug. 31, 2006

(51) Int. Cl. H04N 7/14

(52) U.S. Cl. 348/14.01

(57) ABSTRACT

The present invention provides an image-location imprinter for use with a mobile electronic device. In one embodiment, the image-location imprinter includes a camera configured to create an image associated with a location of the mobile electronic device. Additionally, the image-location imprinter also includes a location designation unit coupled to the camera and configured to provide a location-imprinted image by attaching a designation of the location to the image. In another embodiment, the image-location imprinter further includes an image storage unit coupled to the location designation unit and configured to store the location-imprinted image.

### TECHNICAL FIELD OF THE INVENTION

The present invention is directed, in general, to a mobile electronic device and, more specifically, to an image-location imprinter, a method of imprinting a location on an image and a system employing the imprinter or the method.

### BACKGROUND OF THE INVENTION

Users of mobile electronic devices are being provided with increasing capabilities to perform many of their recreational and occupational activities without having to be tied to a specific location. Features such as video or audio on demand allow downloading and playing of video and audio clips. Many mobile devices, such as mobile phones for example, have become portable entertainment centers that allow viewing of news, weather and sports as well as listening to music or playing cutting-edge games. These capabilities and features allow users to enrich their personal media experience. On the business side, a business user is able to employ Internet-enabled mobile communication devices and personal digital assistants (PDAs) that have made the mobile enterprise a more viable and cost-effective reality, especially for salespeople and service representatives.

The feature sets associated with mobile devices continue to expand. For example, many mobile electronic devices have global positioning system (GPS) capability that provide GPS navigation and allow accurate identification of a current user location. Additionally, many provide a mobile camera. Mobile cameras were initially included in mobile phones to allow the user the novelty of being always “camera-ready” and able to capture a photographic image on demand. These initial cameras provided images that were of limited quality but useful for e-mail attachment and general Internet use. Current mobile cameras have increased resolution and zooming capabilities thereby allowing them to provide an enhanced image quality. Additionally, many of these cameras can also operate as video camcorders thereby providing a video sequence of reasonable length and quality.

Accordingly, what is needed in the art is a way to further improve the feature set of mobile electronic devices to better accommodate the needs of mobile users.

### SUMMARY OF THE INVENTION

To address the above-discussed deficiencies of the prior art, the present invention provides an image-location imprinter for use with a mobile electronic device. In one embodiment, the image-location imprinter includes a camera configured to create an image associated with a location of the mobile electronic device. Additionally, the image-location imprinter also includes a location designation unit coupled to the camera and configured to provide a location-imprinted image by attaching a designation of the location to the image. In another embodiment, the image-location imprinter further includes an image storage unit coupled to the location designation unit and configured to store the location-imprinted image.

In another aspect, the present invention provides a method of imprinting a location on an image for use with a mobile electronic device. The method includes creating an image associated with a location of the mobile electronic device and providing a location-imprinted image by attaching a designation of the location to the image.

The present invention also provides, in yet another aspect, a communication system. The communication system includes a mobile communications network employing a cellular grid, and a mobile communication device coupled to the cellular grid. The mobile communication device includes an embodiment of an image-location imprinter having a camera that creates an image associated with a location of the mobile communication device. The image-location imprinter also has a location designation unit that is coupled to the camera and provides a location-imprinted image by attaching a designation of the location to the image. The image-location imprinter further has an image storage unit that is coupled to the location designation unit and stores the location-imprinted image.

The present invention additionally provides, in still another aspect, a global positioning system (GPS). The GPS includes a satellite positioning network and a mobile electronic device coupled to the satellite positioning network. The mobile electronic device includes an embodiment of an image-location imprinter having a camera that creates an image associated with a location of the mobile communication device. The image-location imprinter also has a location designation unit that is coupled to the camera and provides a location-imprinted image by attaching a designation of the location to the image. The image-location imprinter further has an image storage unit that is coupled to the location designation unit and stores the location-imprinted image.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a mobile system constructed in accordance with the principles of the present invention; and

FIG. 2 illustrates a flow diagram of an embodiment of a method of imprinting a location on an image carried out in accordance with the principles of the present invention.

### DETAILED DESCRIPTION

Embodiments of the present invention provide an enhanced capability for users of mobile electronic devices that are able to determine their location and also employ the ability to capture photographic or video images. For a mobile phone employing a cellular grid, this location may at least be approximated by knowing the location of the serving cell for the mobile phone. A more exact location may be provided for a mobile device that can access a global positioning network. In some cases, the mobile electronic device may be coupled to a global positioning network and a mobile communications network at the same time. In each of these cases, embodiments of the present invention allow location information to be imprinted on the photographic or video images provided by the mobile electronic device.

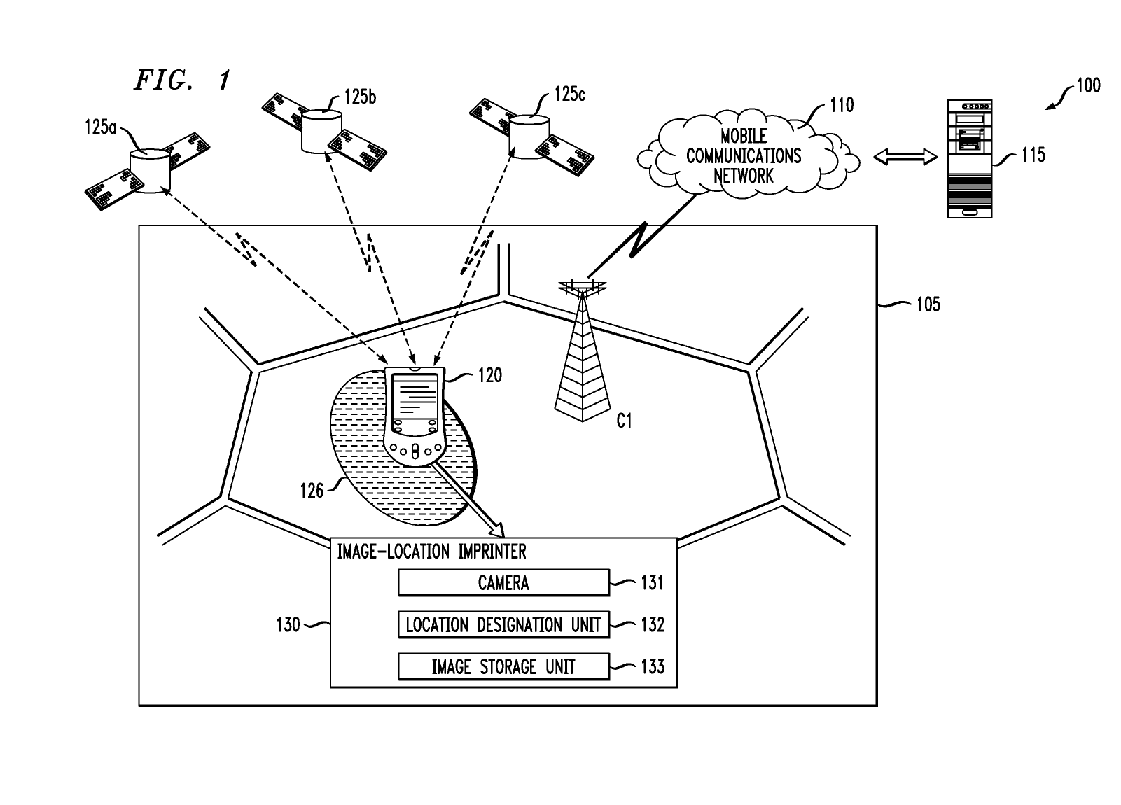

Referring initially to FIG. 1, illustrated is a system diagram of an embodiment of a mobile system, generally designated 100, constructed in accordance with the principles of the present invention. The mobile system 100 includes a communication system having a cellular grid 105 with a plurality of communication cells that are employed with a mobile communications network 110. The mobile communications network 110 is coupled to a network server 115 that functions as a remote storage device for network or other databases. The mobile system 100 also includes a global positioning system (GPS) having a satellite positioning network employing positioning satellites 125a, 125b, 125c. In the illustrated embodiment, the mobile system 100 further includes a mobile device 120 that is coupled to a serving cell C1 of the cellular grid 105 and to the positioning satellites 125a, 125b, 125c.

In the illustrated embodiment, the mobile device 120 includes an image-location imprinter 130 that is functionally coupled to it. The image-location imprinter 130 includes a camera 131 that is configured to create an image associated with a location of the mobile device 120. The image-location imprinter 130 also includes a location designation unit 132 that is coupled to the camera 131 and configured to provide a location-imprinted image by attaching a designation of the location to the image. Additionally, the image-location imprinter 130 further includes an image storage unit 133 that is coupled to the location designation unit 132 and configured to store the location-imprinted image.

The location-imprinted image may employ an image from the camera 131 that is either a photograph or a video frame from a video sequence. In one embodiment, the image location imprinter 130 attaches the designation to the camera image employing a user-initiated attachment mode. In this mode, the user of the mobile device 120 determines if the location designation is to be attached to the image. In another embodiment, the location designation is attached automatically. In one embodiment, the image storage unit 133 may be located in a storage device that is remote from the mobile device 120 such as the network server 115. Alternatively, the image storage unit 133 may be collocated with the mobile device 120.

In one embodiment of the present invention, the communication system conforms to the Global for Mobile Communications/Universal Mobile Telecommunications System (GMS/UMTS) standard. The communication cell C1 employs a GMS mast (transmission antenna) wherein the GMS mast is associated with a Cell-ID. Gathering of these Cell-IDs along with their accompanying locations into a Cell-ID database employing a look-up table correlates Cell-IDs and their locations thereby allowing identification of at least an approximate location for the mobile device 120. In the mobile system 100, the Cell-ID database may be contained in the mobile device 120, or alternatively, it may be maintained in the network server 115 (or another remote storage device) and provided either routinely or upon request to the mobile device 120. The Cell-ID database may be available either publicly or privately.

For an embodiment of the invention where only Cell-ID location information is employed, a location precision of the mobile device 120, using either GSM or UMTS standards, is generally determined by the dimensions or sizes of the communication cells it employs. The mobile device 120 is aware that it is located in the communication cell C1. The mobile device 120 may also be able to receive signals that originate from GMS masts in adjacent communication cells. Therefore, it may be possible to use this adjacent cell information to determine or calculate a more precise location of the mobile device 120 in the communication cell C1, when only Cell-ID information is available.

In the illustrated embodiment, connection of the mobile device 120 to the GPS allows its location to be determined more precisely. A location area 126 may be defined that is considerably smaller than the communication cell C1, as may be seen in FIG. 1. The location area 126 corresponds to a collection of geographic locations that may be employed to designate a particular location landmark, for example. Alternatively, a mobile device location involving a single geographic location may also be employed as a location designation as appropriate to a particular application.

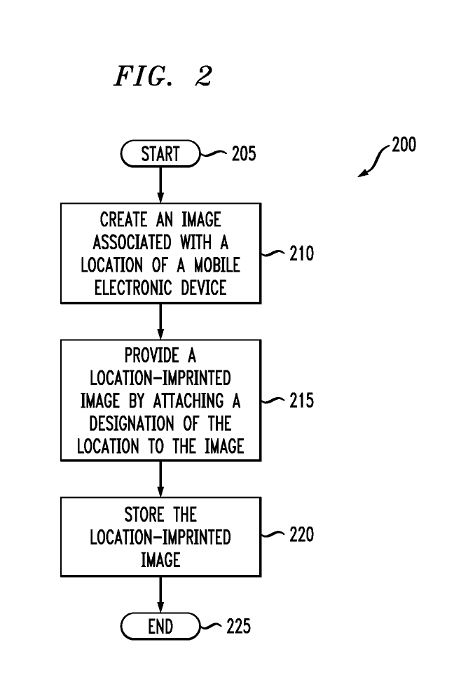

Turning now to FIG. 2, illustrated is a flow diagram of an embodiment of a method of imprinting a location on an image, generally designated 200, carried out in accordance with the principles of the present invention. The method 200 is for use with a mobile electronic device and starts in a step 205. Then, an image associated with a location of the mobile electronic device is created in a step 210. The image may be a photograph or a video frame from a video sequence.

A location-imprinted image is provided by attaching a designation of the location to the image in a step 215. The location-imprinted image may be created employing a user-initiated attachment mode wherein a user decides whether to attach the designation to the image. Alternatively, an automatic attachment mode may be employed to attach the location designation to the image.

In one embodiment, the designation is based on a Cell-ID in a mobile communications network wherein the designation is provided by a look-up table corresponding to the Cell-ID, and the mobile communications network conforms to a Global System for Mobile Communications/Universal Mobile Telecommunications System (GMS/UMTS) standard. In another embodiment, the designation is based on a global positioning system (GPS). The location-imprinted image is stored in a step 220 wherein it may be stored in either a remote storage device or a local storage device. The method 200 ends in a step 225.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing an image-location imprinter, a method of imprinting a location on an image and communication and global positioning systems employing the imprinter or the method have been presented. Advantages include the ability to automatically or manually initiate imprinting of a location designation on an image created at the location of the mobile electronic device. The location-imprinted image created by this action may be stored either locally or remotely depending on the embodiment of the invention employed.

Although the present invention has been described in detail, those skilled in the art should understand that they can make various changes, substitutions and alterations herein without departing from the spirit and scope of the invention in its broadest form.

What is claimed is:

1. An image-location imprinter for use with a mobile electronic device, comprising:
a camera configured to create an image associated with a location of said mobile electronic device; and
a location designation unit coupled to said camera and configured to provide a location-imprinted image by attaching a designation of said location to said image.

2. The imprinter as recited in claim 1 wherein said location-imprinted image employs one selected from the group consisting of:
a photograph; and
a video frame.

3. The imprinter as recited in claim 1 wherein attaching said designation to said image employs one selected from the group consisting of:
a user-initiated attachment mode; and
an automatic attachment mode.

4. The imprinter as recited in claim 1 wherein said designation is based on a Cell-ID in a mobile communications network.

5. The imprinter as recited in claim 4 wherein said designation is provided by a look-up table corresponding to said Cell-ID.

6. The imprinter as recited in claim 1 wherein said designation is based on a global positioning system (GPS).

7. The imprinter as recited in claim 1 further comprising an image storage unit coupled to said location designation unit and configured to store said location-imprinted image.

8. The imprinter as recited in claim 7 wherein said location-imprinted image is stored in one selected from the group consisting of:
a remote storage device; and
a local storage device.

9. A method of imprinting a location on an image for use with a mobile electronic device, comprising:
creating an image associated with a location of said mobile electronic device; and
providing a location-imprinted image by attaching a designation of said location to said image.

10. The method as recited in claim 9 wherein said location-imprinted image employs one selected from the group consisting of:
a photograph; and
a video frame.

11. The method as recited in claim 9 wherein attaching said designation to said image employs one selected from the group consisting of:
a user-initiated attachment mode; and
an automatic attachment mode.

12. The method as recited in claim 9 wherein said designation is based on a Cell-ID in a mobile communications network.

13. The method as recited in claim 12 wherein said designation is provided by a look-up table corresponding to said Cell-ID.

14. The method as recited in claim 9 wherein said designation is based on a global positioning system (GPS).

15. The method as recited in claim 9 further comprising storing said location-imprinted image.

16. The method as recited in claim 15 wherein said location-imprinted image is stored in one selected from the group consisting of:
a remote storage device; and
a local storage device.

17. A communication system; comprising:
a mobile communications network employing a cellular grid;
a mobile communication device coupled to said cellular grid; and
an image-location imprinter coupled to said mobile communication device, including:
a camera that creates an image associated with a location of said mobile communication device;
a location designation unit that is coupled to said camera and provides a location-imprinted image by attaching a designation of said location to said image; and
an image storage unit that is coupled to said location designation unit and stores said location-imprinted image.

18. The system as recited in claim 17 wherein said designation is based on a Cell-ID in said mobile communications network.

19. The system as recited in claim 18 wherein said designation is provided by a look-up table corresponding to said Cell-ID.

20. The system as recited in claim 17 wherein said mobile communications network conforms to a Global System for Mobile Communications/Universal Mobile Telecommunications System (GMS/UMTS) standard.

21. A global positioning system (GPS), comprising:
a satellite positioning network;
a mobile electronic device coupled to said satellite positioning network; and
an image-location imprinter coupled to said mobile communication device, including:
a camera that creates an image associated with a location of said mobile communication device;
a location designation unit that is coupled to said camera and provides a location-imprinted image by attaching a designation of said location to said image; and
an image storage unit that is coupled to said location designation unit and stores said location-imprinted image.

22. The GPS as recited in claim 21 wherein said designation of said location is provided as a geographic location.
